(19) United States
(12) Patent Application Publication
(10) Pub. No.: US 2018/0260388 A1
(43) Pub. Date: Sep. 13, 2018

(54) HEADSET-BASED TRANSLATION SYSTEM

(71) Applicant: Jetvox Acoustic Corp., Taoyuan City (TW)

(72) Inventors: To-Teng HUANG, Taoyuan City (TW); Shih-Yuan CHEN, Taoyuan City (TW)

(21) Appl. No.: 15/669,317

(22) Filed: Aug. 4, 2017

(30) Foreign Application Priority Data
Mar. 8, 2017 (TW) 106107567

(51) Int. Cl. G06F 17/28; G10L 13/02; G10L 15/30; H04M 1/05

(52) U.S. Cl. CPC G06F 17/289; H04M 1/05; G10L 15/30; G10L 13/02

(57) ABSTRACT

A headset-based translation system includes a first headset device, a second headset device, and a cloud-translating server. Each headset device includes an audio-receiving unit, a wireless receiving-transmitting unit, and a speaker unit. The audio-receiving unit receives a speech and converts the speech into an audio signal. The wireless receiving-transmitting unit wireless transmits the audio signal and receives a translated signal. The cloud-translating server receives the first audio signal from the first headset device and the second audio signal from the second headset device and translates the first audio signal and the second audio signal into a first translated signal and a second translated signal, respectively. The cloud-translating server then transmits the first translated signal and the second translated signal to the second wireless receiving-transmitting unit and the first wireless receiving-transmitting unit, respectively. The first speech and the second speech belong to different languages.

### CROSS-REFERENCE TO RELATED APPLICATION

This non-provisional application claims priority under 35 U.S.C. § 119(a) to Patent Application No. 106107567 filed in Taiwan, R.O.C. on Mar. 8, 2017, the entire contents of which are hereby incorporated by reference.

### BACKGROUND

### Technical Field

The instant disclosure relates to voice translation technologies, in particular, to a headset-based translation system.

### Related Art

Along with the globalization and blooms of international travels, communicating with people having different languages becomes an inevitable issue. In conventional, a user needs to use a translation device, a translation application of the mobile phone, or a cloud translation system for translation. However, these conventional approaches fail to provide instant translation services, and the user has to hold the translation device or the mobile phone, resulting in inconvenience in operation.

Moreover, the mobile phone or the translation device are commonly have operating systems with great sizes and have many application programs, resulting in speed reduction in computation and transmission for the translation. Even though the conventional translation systems are continuously improved by artificial intelligence algorithm to have a translated output suitable for the corresponding language, the size of the software and database becomes bigger and bigger along with the improvements of the software, resulting in the speed reduction in computation and transmission for the translation.

### SUMMARY

In view of these problems, a headset-based translation system is provided. In one embodiment, the headset-based translation system comprises a first headset device, a second headset device, and a cloud translating server. The first headset device comprises a first audio receiving unit, a first wireless transmitting-receiving unit, and a first speaker unit. The first audio receiving unit receives a first speech and converts the first speech into a first audio signal. The first wireless transmitting-receiving unit is electrically connected to the first audio receiving unit. The first wireless transmitting-receiving unit receives the first audio signal and wirelessly transmits the first audio signal out. The first wireless transmitting-receiving unit wirelessly receives a second translated signal. The first speaker unit is electrically connected to the first wireless transmitting-receiving unit, and the first speaker unit receives the second translated signal, converts the second translated signal into a second translated speech, and plays the second translated speech. The second headset device comprises a second audio receiving unit, a second wireless transmitting-receiving unit, and a second speaker unit. The second audio receiving unit receives a second speech and converts the second speech into a second audio signal. The second wireless transmitting-receiving unit is electrically connected to the second audio receiving unit. The second wireless transmitting-receiving unit receives the second audio signal and wirelessly transmits the second audio signal out. The second wireless transmitting-receiving unit wirelessly receives a first translated signal. The second speaker unit is electrically connected to the second wireless transmitting-receiving unit. The second speaker unit receives the first translated signal, converts the first translated signal into a first translated speech, and plays the first translated speech. The cloud translating server is in communication with the first wireless transmitting-receiving unit and the second wireless transmitting-receiving unit. The cloud translating server receives the first audio signal, translates the first audio signal to the first translated signal, and wirelessly transmits the first translated signal to the second wireless transmitting-receiving unit. The cloud translating server receives the second audio signal, translates the second audio signal to the second translated signal, and wirelessly transmits the second translated signal to the first wireless transmitting-receiving unit. The first speech and the second speech belong to different languages. The first speech and the second translated speech played by the first speaker unit belong to a same language or different languages.

In one embodiment, the first headset device has first identification information, the second headset device has second identification information, and the cloud translating server stores an identification correspondence table. The identification correspondence table stores the first identification information, the second identification information, and respective languages suitable for the first and second identification information. The cloud translating server checks the identification correspondence table to generate the first translated signal having a language suitable for the second identification information by translation and wirelessly transmits the first translated signal to the second wireless transmitting-receiving unit and to generate the second translated signal having a language suitable for the first identification information by translation and wirelessly transmits the second translated signal to the first wireless transmitting-receiving unit.

Moreover, in one embodiment, the first headset device comprises a first memory module, the second headset device comprises a second memory module, and the first memory module and the second memory module respectively store the first identification information and the second identification information.

In one embodiment, the first audio signal and the second audio signal are uncompressed audio code or compressed audio code.

In one embodiment, the first translated signal and the second translated signal are uncompressed audio code or compressed audio code.

In one embodiment, each of the first wireless transmitting-receiving unit and the second wireless transmitting-receiving unit comprises a long-distance wireless transceiver. The long-distance wireless transceiver of the first wireless transmitting-receiving unit and the long-distance wireless transceiver of the second wireless transmitting-receiving unit are respectively in wireless communication with the cloud translating server.

In one embodiment, each of the first wireless transmitting-receiving unit and the second wireless transmitting-receiving unit comprises a short-distance wireless transceiver. The short-distance wireless transceiver of the first wireless transmitting-receiving unit and the short-distance wireless transceiver of the second wireless transmitting-receiving unit are respectively in wireless communication with a wireless router. The wireless router is in communication with the cloud translating server.

In one embodiment, the first audio receiving unit comprises a first microphone, and the second audio receiving unit comprises a second microphone. The first microphone and the second microphone are bone conduction microphones or micro-electromechanical systems microphones.

In one embodiment, the cloud translating server further generates a feedback signal and wirelessly transmits the feedback signal to the first wireless transmitting-receiving unit or the second wireless transmitting-receiving unit. The feedback signal is a feedback audio signal, an instruction, or a combination thereof. Furthermore, the feedback signal is played by the first speaker unit and the second speaker unit, or the feedback signal enables a first instruction unit of the first headset device and a second instruction unit of the second headset device to perform a corresponding operation for the feedback signal.

Based on the above, some embodiments of the headset devices of the headset-based translation system are directly in communication wirelessly with the cloud translating server for transmitting the speeches without the headset devices' recognition of the speeches. Furthermore, an intermediate device such as a mobile phone or a host is not needed for the computation, the translation or the transmission. Therefore, the speed for transmission and computation can be improved. Furthermore, because the headset-based translation system utilizes the cloud translating server to perform the translation, the first and the second headset devices do not require any build-in translation chips and the software installed in the first and the second headset devices would not require to be updated. Accordingly, user needs can be satisfied.

### BRIEF DESCRIPTION OF THE DRAWINGS

The disclosure will become more fully understood from the detailed description given herein below for illustration only, and thus not limitative of the disclosure, wherein:

FIG. 1 illustrates a schematic view of a headset-based translation system according to an embodiment of the instant disclosure;

FIG. 2 illustrates a block diagram of FIG. 1;

FIG. 3 illustrates a block diagram of one embodiment of wireless transmission of the headset-based translation system shown in FIG. 2;

FIG. 4 illustrates a block diagram of another embodiment of wireless transmission of the headset-based translation system shown in FIG. 2;

FIG. 5 illustrates a schematic view of the headset-based translation system according to another embodiment of the instant disclosure; and

FIG. 6 illustrates a flowchart for operating the headset-based translation system of the embodiment.

### DETAILED DESCRIPTION

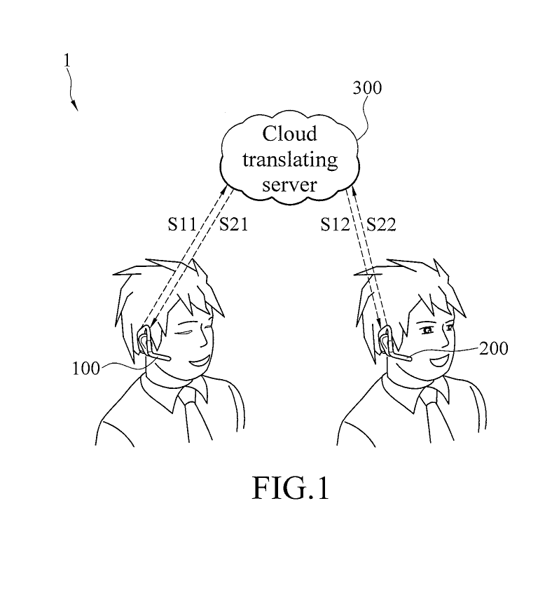

FIG. 1 illustrates a schematic view of a headset-based translation system according to an embodiment of the instant disclosure. As shown in FIG. 1, the headset-based translation system 1 comprises a first headset device 100, a second headset device 200, and a cloud translating server 300. The first headset device 100 wirelessly transmits a first audio signal S11. The cloud translating server 300 receives the first audio signal S11, translates the first audio signal S11 to a first translated signal S12 suitable for the second headset device 200, and transmits the first translated signal S12 to the second headset device 200. The second headset device 200 wirelessly transmits a second audio signal S22. The cloud translating server 300 receives the second audio signal S22, translates the second audio signal S22 to a second translated signal S21 suitable for the first headset device 100, and transmits the second translated signal S21 to the first headset device 100.

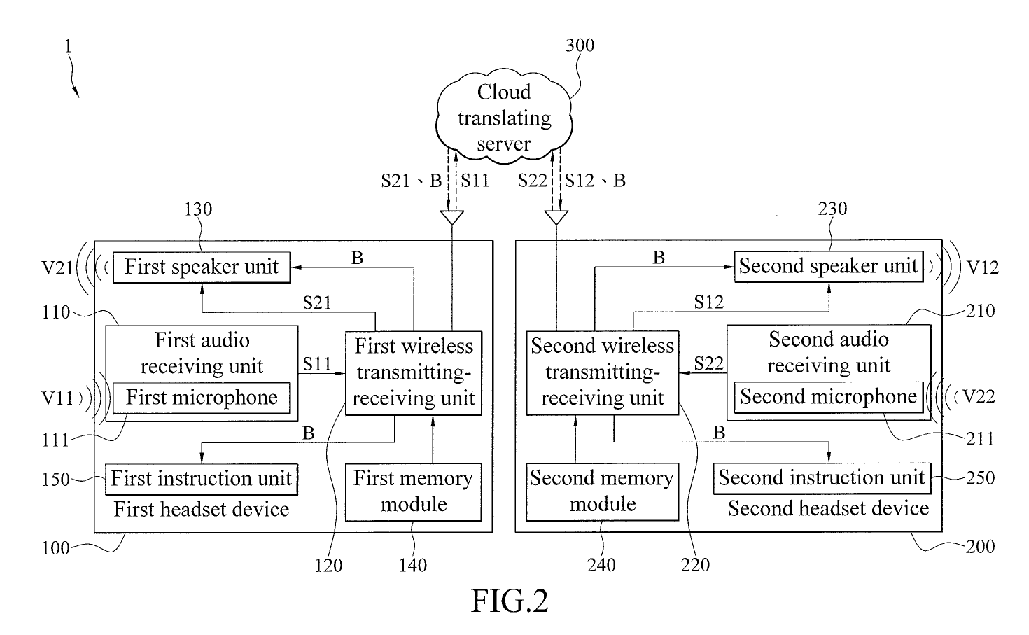

FIG. 2 illustrates a block diagram of FIG. 1. As shown in FIG. 2, the first headset device 100 comprises a first audio receiving unit 110, a first wireless transmitting-receiving unit 120, and a first speaker unit 130. The first audio receiving unit 110 receives a first speech V11 and converts the first speech V11 into the first audio signal S11. The conversion between the first speech V11 and the first audio signal S11 is a transformation between voice and electrical signal, and the conversion manner for generating the first audio signal S11 as well as the format of the converted first audio signal S11 are not limited. The first wireless transmitting-receiving unit 120 is electrically connected to the first audio receiving unit 110. The first wireless transmitting-receiving unit 120 receives the first audio signal S11 and wirelessly transmits the first audio signal S11 out. The first wireless transmitting-receiving unit 120 further wirelessly receives the second translated signal S21 from outside. The first speaker unit 130 is electrically connected to the first wireless transmitting-receiving unit 120. The first speaker unit 130 receives the second translated signal S21, converts the second translated signal S21 to a second translated speech V21, and plays the second translated speech V21. The conversion between the second translated signal S21 and the second translated speech V21 is a transformation between electrical signal and voice, and the second translated signal S21 corresponds to a language set for the first headset device 100.

The second headset device 200 comprises a second audio receiving unit 210, a second wireless transmitting-receiving unit 220, and a second speaker unit 230. The second audio receiving unit 210 receives a second speech V22 and converts the second speech V22 into the second audio signal S22. Similarly, the conversion between the second speech V22 and the second audio signal S22 is a transformation between voice and electrical signal, and the conversion manner for generating the second audio signal S22 as well as the format of the converted second audio signal S22 are not limited. The second wireless transmitting-receiving unit 220 is electrically connected to the second audio receiving unit 210. The second wireless transmitting-receiving unit 220 receives the second audio signal S22 and wirelessly transmits the second audio signal S22 out. The second wireless transmitting-receiving unit 220 further wirelessly receives the first translated signal S12 from outside. The second speaker unit 230 is electrically connected to the second wireless transmitting-receiving unit 220. The second speaker unit 230 receives the first translated signal S12, converts the first translated signal S12 into a first translated speech V12, and plays the first translated speech V12. The conversion between the first translated signal S12 and the first translated speech V12 is a transformation between electrical signal and voice.

The cloud translating server 300 is in communication with the first wireless transmitting-receiving unit 120 and the second transmitting-receiving unit 220. The cloud translating server 300 receives the first audio signal S11, translates the first audio signal S11 to the first translated signal S12, and wirelessly transmits the first translated signal S12 to the second wireless transmitting-receiving unit 220. The cloud translating server 30 further receives the second audio signal S22, translates the second audio signal S22 to the second translated signal S21, and wirelessly transmits the second translated signal S21 to the first wireless transmitting-receiving unit 120.

In this embodiment, the first speech V11 and the second speech V22 belong to different languages, and the user of the first headset device 100 and the user of the second headset device 200 use their mother languages to speak to the first headset device 100 and the second headset device 200, respectively. The first speech V11 and the second translated speech V21 played by the first speaker unit 130 belong to the same language or different languages. In other words, the second translated speech V21 played by the first speaker unit 130 and heard by the user of the first headset device 100 is a language the user of the first headset device 100 can understand, and the first translated speech V12 played by the second speaker unit 230 and heard by the user of the second headset device 200 is a language the user of the second headset device 200 can understand. For example, the user wearing the first headset device 100 and the user wearing the second headset device 200 use different languages, and the first headset device 100 and the second headset device 200 can be matched with the cloud translating server 300 to receive translated signals in preset languages. For instance, in the case that the first speech V11 is Chinese and the second speech V22 is French, the second translated speech V21 played by the first speaker unit 130 may be Chinese, English, or other languages that can be understood by the user of the first headset device 100.

Accordingly, the first headset device 100 has first identification information and the second headset device 200 has second identification information. After the first headset device 100 and the second headset device 200 are matched with each other, the cloud translating server 300 accesses the first identification information and the second identification information, and the cloud translating server 300 stores an identification correspondence table. The identification correspondence table stores the first identification information, the second identification information, and respective suitable languages for the first and second identification information. In the identification correspondence table, the language suitable for the first identification information as well as the language suitable for the second identification information may be set when the first headset device 100 matches with the second headset device 200. Or, the suitable languages for the respective identification information may be set by connecting a device (such as a personal computer, a tablet computer, or a smart phone) with the cloud translating server 300 in advance, and then the identification correspondence table is automatically downloaded from the cloud translating server 300 when the first headset device 100 matches with the second headset device 200. After the cloud translating server 300 receives the first audio signal S11, the cloud translating server 300 checks the identification correspondence table to generate the first translated signal S12 having a language suitable for the second identification information by translation and wirelessly transmits the first translated signal S12 to the second wireless transmitting-receiving unit 220. After the cloud translating server 300 receives the second audio signal S22, the cloud translating server 300 checks the identification correspondence table to generate the second translated signal S21 having a language suitable for the first identification information by translation and wirelessly transmits the second translated signal S21 to the first wireless transmitting-receiving unit 120. Moreover, as shown in FIG. 2, the first headset device 100 comprises a first memory module 140, the second headset device 200 comprises a second memory module 240, and the first memory module 140 stores the first identification information and the second memory module 240 stores the second identification information, respectively.

In this embodiment, the first audio signal S11 and the second audio signal S22 may be lossless compressed audio code (with filename extension of “.flac”), so that the file size can be compressed without distortion for rapid transmission, thereby facilitating in recognition by the cloud server 300 and in the translation task. In detail, in some embodiments, the first voice receiving unit 110 and the second voice receiving unit 210 may, but not limited to, respectively convert the first speech V11 in analog format and the second speech V22 in analog format into the first audio signal S11 in digital uncompressed audio code format (with filename extension of “.wav”) and the second audio signal S22 in digital uncompressed audio code format (with filename extension of “.wav”), and further respectively convert the first audio signal S11 in digital uncompressed audio code format and the second audio signal S22 in digital uncompressed audio code format into the first audio signal S11 in digital lossless compressed audio code format (with filename extension of “.flac”) and the second audio signal S22 in digital lossless compressed audio code format (with filename extension of “.flac”), and the first audio signal S11 in digital lossless compressed audio code format and the second audio signal S22 in digital lossless compressed audio code format are thus respectively transmitted by the first wireless transmitting-receiving unit 120 and the second wireless transmitting-receiving unit 220. In another embodiment, the first voice receiving unit 110 and the second voice receiving unit 210 may only respectively receive the first speech V11 in analog format and the second speech V22 in analog format and respectively convert the first speech V11 in analog format and the second speech V22 in analog format into the first audio signal S11 in digital uncompressed audio code format (with filename extension of “.wav”) and the second audio signal S22 in digital uncompressed audio code format (with filename extension of “.wav”), and the first audio signal S11 in digital uncompressed audio code format and the second audio signal S22 in digital uncompressed audio code format are respectively wirelessly transmitted to the cloud translating server 300 by the first wireless transmitting-receiving unit 120 or the second wireless transmitting-receiving unit 220. The first audio signal S11 in digital uncompressed audio code format (with filename extension of “.wav”) and the second audio signal S22 in digital uncompressed audio code format (with filename extension of “.wav”) are then converted into the first audio signal S11 in digital lossless compressed audio code format (with filename extension of “.flac”) and the second audio signal S22 in digital lossless compressed audio code format (with filename extension of “.flac”). Next, the recognition and translation for audio signals are performed.

In other words, it is understood that, the format of the first audio signal S11 as well as that of the second audio signal S22 are not limited to the aforementioned embodiments, and the first audio signal S11 as well as the second audio signal S22 may be uncompressed audio code or compressed audio code. Compressed audio code may be lossless compressed audio code, e.g., with filename extension of “.flac” and “.ape”, or may be distorted compressed audio code, e.g., with filename extension of “.mp3”, “.wma”, and “.ogg”.

Similarly, the first translated signal S12 as well as the second translated signal S21 may be lossless compressed audio code (with filename extension of “.flac”), so that the file size can be compressed without distortion for rapid transmission, thereby facilitating in recognition. It is understood that the format of the first translated signal S12 as well as that of the second translated signal S21 are not limited, and the first translated signal S12 as well as the second translated signal S21 may be uncompressed audio code or compressed audio code.

Furthermore, the first audio receiving unit 110 comprises a first microphone 111, and the second audio receiving unit 210 comprises a second microphone 211. The first microphone 111 and the second microphone 211 may be, but not limited to, micro-electromechanical systems (MEMS) microphone or bone conduction microphones. It is understood that, the first speech V11 and the second speech V22 may be received by microphones in other types.

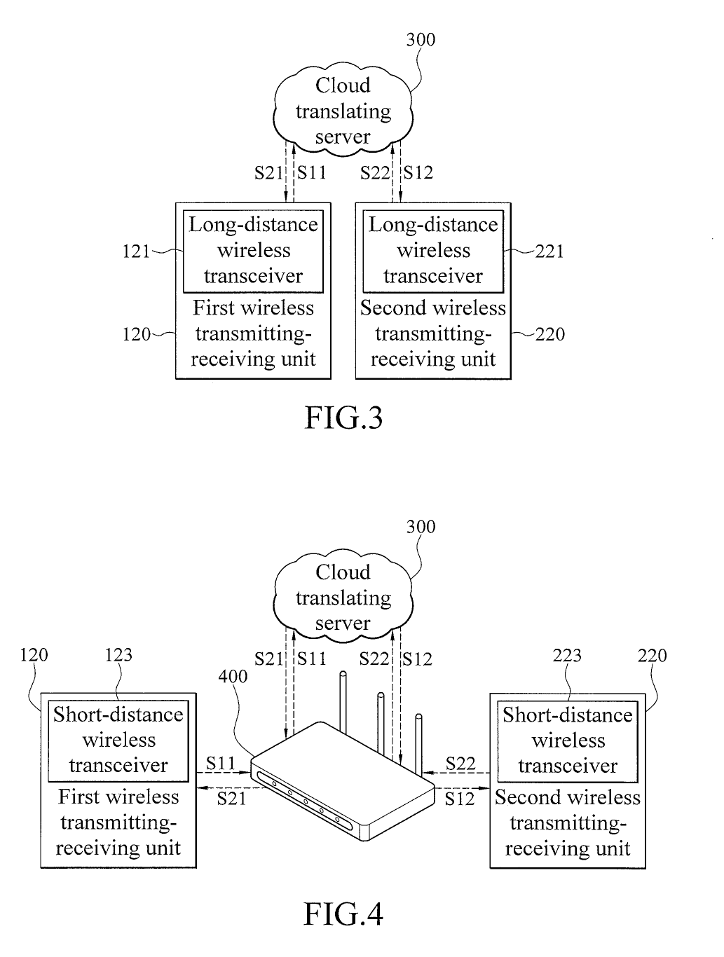

FIG. 3 illustrates a block diagram of one embodiment of wireless transmission of the headset-based translation system shown in FIG. 2. As shown in FIG. 3, the first wireless transmitting-receiving unit 120 comprises a long-distance wireless transceiver 121 and the second wireless transmitting-receiving unit 220 comprises a long-distance wireless transceiver 221. The long-distance wireless transceivers 121, 221 may be wireless transceivers with 3G/4G interfaces or other mobile data communication protocol standards. The long-distance wireless transceivers 121, 221 may be in wireless communication with the cloud translating server 300, respectively. In other words, the first headset device 100 and the second headset device 200 may be regarded as mobile data devices and directly in communication with mobile data internet.

FIG. 4 illustrates a block diagram of another embodiment of wireless transmission of the headset-based translation system shown in FIG. 2. As shown in FIG. 4, the first wireless transmitting-receiving unit 120 comprises a short-distance wireless transceiver 123 and the second wireless transmitting-receiving unit 220 comprises a short-distance wireless transceiver 223. The short-distance wireless transceivers 123, 223 are in wireless communication with a wireless router 400, and the wireless router 400 is in wireless communication with the cloud translating server 300. In this embodiment, the short-distance wireless transceivers 123, 223 may be conformed to Wi-Fi, Zigbee, Bluetooth, near-field communication interfaces, and the short-distance wireless transceivers 123, 223 are connected to Internet via the wireless router 400 so as to be in communication with the cloud translating server 300.

Please refer to FIG. 2. The cloud translating server 300 further generates a feedback signal B, and the cloud translating server 300 wirelessly transmits the feedback signal B to the first wireless transmitting-receiving unit 120 and/or the second wireless transmitting-receiving unit 220. The feedback signal B may be a feedback audio signal, an instruction, or a combination thereof. Furthermore, the feedback signal B may be played by the first speaker unit 130 and the second speaker unit 230; or, the feedback signal B may enable a first instruction unit 150 of the first headset device 100 and a second instruction unit 250 of the second headset device 200 to perform a corresponding operation for the feedback signal B. For example, when the cloud translating server 300 is matched with the first headset device 100 and the second headset device 200 and the server is in communication with the headset devices, the cloud translating server 300 may generate a feedback signal B in audio format, and the feedback signal B is transmitted to the first wireless transmitting-receiving unit 120 and the second wireless transmitting-receiving unit 220 and is played by the first speaker unit 130 and the second speaker unit 230. In another example, when the signal-to-noise ratio of the first audio signal S11 is too low (i.e., the background noise is too strong) to be read by the cloud translating server 300, the cloud translating server 300 transmits the feedback signal B to the first wireless transmitting-receiving unit 120. In such case, the first instruction unit 150 or the second instruction unit 250 may be indicating lamps or oscillators. When the matching between the cloud translating server 300, the first headset device 100, and the second headset device 200 is completed or when the signal-to-noise ratio of the audio signal is too low, the feedback signal B may be an instruction to enable the first instruction unit 150 or the second instruction unit 250 to perform a corresponding operation for the feedback signal B. The operation may be activating a lamp to emit twinkling blue light or activating an oscillator to perform a combined vibration having one long vibration followed with two short vibrations. It is understood that, the examples to the feedback signal as well as that to the instruction units are not limitations to the instant disclosure.

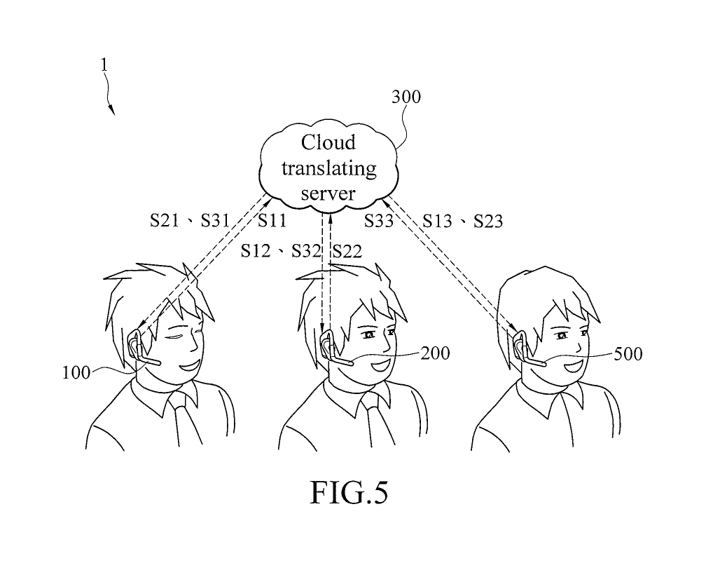

FIG. 5 illustrates a schematic view of the headset-based translation system according to another embodiment of the instant disclosure. As shown in FIG. 5, the headset-based translation system 1 further comprises a third headset device 500. The cloud translating server 300 further receives a third audio signal S33, as well as translating the third audio signal S33 to a third translated signal S31 corresponding to the language used by the user of the first headset device 100 and translating the third audio signal S33 to a third translated signal S32 corresponding to the language used by the user of the second headset device 200. Then, the cloud translating server 300 transmits the third translated signals S31, S32 to the first headset device 100 and the third headset device 500, respectively. The cloud translating server 300 also translates the first audio signal S11 to the first translated signal S12 corresponding to the language used by the user of the second headset device 200 and translates the first audio signal S11 to a first translated signal S13 corresponding to the language used by the user of the third headset device 500, and the cloud translating server 300 transmits the first translated signals S12, S13 to the second headset device 200 and the third headset device 500, respectively. Further, the cloud translating server 300 also translates the second audio signal S22 to the second translated signal S21 corresponding to the language used by the user of the first headset device 100 and translates the second audio signal S22 to a second translated signal S23 corresponding to the language used by the user of the third headset device 500, and the cloud translating server 300 transmits the second translated signals S21, S23 to the first headset device 100 and the third headset device 500, respectively. In other words, in this embodiment, the headset-based translation system 1 can be used for facilitating a multi-way communication which is more suitable to be applied in youth hostels, backpacker hostels, student dormitories, or other occasions with people in multiple nationalities and multiple languages.

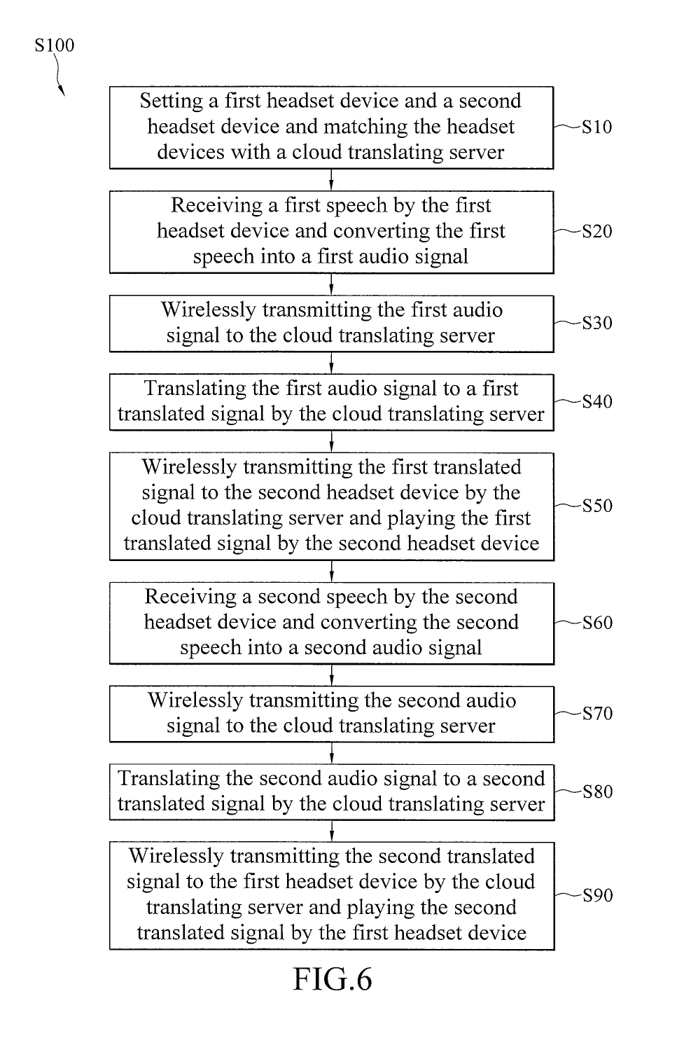

FIG. 6 illustrates a flowchart for operating the headset-based translation system of the embodiment. As shown in FIG. 6, the operating method S100 comprises steps S10 to S90. Please refer to FIG. 2, in the step S10, the first headset device 100 and the second headset device 200 are set and matched with the cloud translating server 300. In this embodiment, the user may match the first headset device 100, the second headset device 200, and the cloud translating server 300 with each other to allow the wireless communication therebetween via a mobile phone, a tablet computer, or a personal computer. The cloud translating server 300 accesses the first identification information in the first headset device 100 and the second identification information in the second headset device 200 and stores the identification correspondence table. The correspondence table records the first identification information, the second identification information, and respective suitable languages for the first and second identification information. After the step S10, the computer, the mobile phone, or the tablet computer are not needed for subsequent operations.

In the step S20, the first headset device 100 receives the first speech V11, and the first audio receiving unit 110 converts the first speech V11 into the first audio signal S11. In the step S30, the first audio signal S11 is wirelessly transmitted to the cloud translating server 300 via the first wireless transmitting-receiving unit 120. In the step S40, the cloud translating server 300 checks the identification correspondence table to generate the first translated signal S12 having the language suitable for the second identification information by translation. In the step S50, the cloud translating server 300 wirelessly transmits the first translated signal S12 to the second headset device 200, the first translated signal S12 is converted into the first translated speech V12 by the second speaker unit 230, and the first translated speech V12 is played by the second speaker unit 230.

In the step S60, the second headset device 200 receives the second speech V22, and the second audio receiving unit 210 converts the second speech V22 into the second audio signal S22. In the step S70, the second audio signal S22 is wirelessly transmitted to the cloud translating server 300 via the second wireless transmitting-receiving unit 220. In the step S80, the cloud translating server 300 checks the identification correspondence table to generate the second translated signal S21 having the language suitable for the first identification information by translation. In the step S90, the cloud translating server 300 wirelessly transmits the second translated signal S21 to the first headset device 100, and the second translated signal S21 is converted into the second translated speech V21 by the first speaker unit 130, and the second translated speech V21 is played by the first speaker unit 130. Accordingly, a two-way communication (or more) can be achieved by translation.

Based on the above, in the foregoing embodiments, the first headset device 100 and the second headset device 200 of the headset-based translation system 1 are directly in communication wirelessly with the cloud translating server 300, and an intermediate device such as a mobile phone or a host is not needed for the computation, translation, or transmission of. Therefore, the speed for transmission and computation can be improved. Furthermore, because the headset-based translation system 1 utilizes the cloud translating server 300 to perform the translation, the first headset device 100 and the second headset device 200 do not require any build-in translation chips and the software installed in the first headset device 100 and the second headset device 200 would not require to be updated. Accordingly, user needs can be satisfied.

What is claimed is:

1. A headset-based translation system, comprising:
a first headset device, comprising a first audio receiving unit, a first wireless transmitting-receiving unit, and a first speaker unit, the first audio receiving unit receiving a first speech and converting the first speech into a first audio signal, the first wireless transmitting-receiving unit being electrically connected to the first audio receiving unit, the first wireless transmitting-receiving unit receiving the first audio signal and wirelessly transmitting the first audio signal out, the first wireless transmitting-receiving unit wirelessly receiving a second translated signal, the first speaker unit being electrically connected to the first wireless transmitting-receiving unit, the first speaker unit receiving the second translated signal, converting the second translated signal into a second translated speech, and playing the second translated speech;
a second headset device, comprising a second audio receiving unit, a second wireless transmitting-receiving unit, and a second speaker unit, the second audio receiving unit receiving a second speech and converts the second speech into a second audio signal, the second wireless transmitting-receiving unit being electrically connected to the second audio receiving unit, the second wireless transmitting-receiving unit receiving the second audio signal and wirelessly transmitting the second audio signal out, the second wireless transmitting-receiving unit wirelessly receiving a first translated signal, the second speaker unit being electrically connected to the second wireless transmitting-receiving unit, the second speaker unit receiving the first translates signal, converting the first translated signal into a first translated speech, and playing the first translated speech; and
a cloud translating server being in communication with the first wireless transmitting-receiving unit and the second wireless transmitting-receiving unit, the cloud translating server receiving the first audio signal, translating the first audio signal into the first translated signal, and wirelessly transmitting the first translated signal to the second wireless transmitting-receiving unit, the cloud translating server further receiving the second audio signal, translating the second audio signal into the second translated signal, and wirelessly transmitting the second translated signal to the first wireless transmitting-receiving unit;
wherein, the first speech and the second speech belong to different languages, the first speech and the second translated speech played by the first speaker unit belong to a same language or different languages.

2. The headset-based translation system according to claim 1, wherein the first headset device has first identification information, the second headset device has second identification information, the cloud translating server stores an identification correspondence table, the identification correspondence table stores the first identification information, the second identification information, and respective languages suitable for the first and second identification information, the cloud translating server checks the identification correspondence table to generate the first translated signal having a language suitable for the second identification information by translation and wirelessly transmits the first translated signal to the second wireless transmitting-receiving unit and to generate the second translated signal having a language suitable for the first identification information by translation and wirelessly transmits the second translated signal to the first wireless transmitting-receiving unit.

3. The headset-based translation system according to claim 2, wherein the first headset device comprises a first memory module, the second headset device comprises a second memory module, the first memory module and the second memory module respectively store the first identification information and the second identification information.

4. The headset-based translation system according to claim 1, wherein the first audio signal and the second audio signal are uncompressed audio code or compressed audio code.

5. The headset-based translation system according to claim 1, wherein the first translated signal and the second translated signal are uncompressed audio code or compressed audio code.

6. The headset-based translation system according to claim 1, wherein each of the first wireless transmitting-receiving unit and the second wireless transmitting-receiving unit comprises a long-distance wireless transceiver, the long-distance wireless transceiver of the first wireless transmitting-receiving unit and the long-distance wireless transceiver of the second wireless transmitting-receiving unit are respectively in wireless communication with the cloud translating server.

7. The headset-based translation system according to claim 1, wherein each of the first wireless transmitting-receiving unit and the second wireless transmitting-receiving unit comprises a short-distance wireless transceiver, the short-distance wireless transceiver of the first wireless transmitting-receiving unit and the short-distance wireless transceiver of the second wireless transmitting-receiving unit are respectively in wireless communication with a wireless router, the wireless router is in communication with the cloud translating server.

8. The headset-based translation system according to claim 1, wherein the first audio receiving unit comprises a first microphone, the second audio receiving unit comprises a second microphone, the first microphone and the second microphone are bone conduction microphones or micro-electromechanical systems microphones.

9. The headset-based translation system according to claim 1, wherein the cloud translating server further generates a feedback signal and wirelessly transmits the feedback signal to the first wireless transmitting-receiving unit or the second wireless transmitting-receiving unit, wherein the feedback signal is a feedback audio signal, an instruction, or a combination thereof.

10. The headset-based translation system according to claim 9, wherein the feedback signal is played by the first speaker unit and the second speaker unit, or the feedback signal enables a first instruction unit of the first headset device and a second instruction unit of the second headset device to perform a corresponding operation for the feedback signal.
